(19) United States
(12) Patent Application Publication
(10) Pub. No.: US 2021/0009346 A1
(43) Pub. Date: Jan. 14, 2021

(54) Bravo Waste Bin, An Apparatus for the Storage of Waste and Tools for Cleaning and Waste Collection

(71) Applicant: Hector Bravo, Fresno, CA (US)

(72) Inventor: Hector Bravo, Fresno, CA (US)

(21) Appl. No.: 16/505,568

(22) Filed: Jul. 8, 2019

(51) Int. Cl. B65F 1/00; B65F 1/14; A47L 13/51

(52) U.S. Cl. CPC B65F 1/0053; A47L 13/51; B65F 1/141

(57) ABSTRACT

The Bravo Waste Bin is an all-in-one waste bin with two compartments, one compartment for the storage of waste, and one compartment for the storage of the tools and supplies necessary for cleaning and waste removal. The Bravo Waste Bin allows the users and businesses to store the tools and cleaning supplies for cleaning and waste removal in a convenient location, reduce clutter, and improve sanitation.

### CROSS-REFERENCE TO RELATED APPLICATIONS

The inventor is also filing a design patent application for the Bravo Waste Bin.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Bravo Waste Bin (Bravo Waste Bin) is an all-in-one bin, which includes a waste bin, and a storage compartment to store cleaning tools and supplies, such as a broom with an adjustable handle, a mini-sweep with dustpan, a mesh pouch to hold trash bags, a hanging hook for a fly swatter, and other small and necessary cleaning tools and supplies.

The Bravo Waste Bin enables households and businesses to discretely store waste and needed cleaning tools and supplies in the same location for convenience, access, reducing clutters, and improving sanitation at the same time.

Currently, the waste bin is a stand-alone item, and cleaning tools such as brooms, dust pans, trash bags, and other related items are stored at different locations, outside of the bins. These items are often misplaced and difficult to locate when needed. They are also clutters when scattered. In addition, these tools are often not clean, and they can become a sanitation issue, especially in a confined space.

Therefore, the Bravo Waste Bin is designed as an all-in-one storage for waste, tools for waste collection, and cleaning supplies, providing a convenient and sanitary solution.

### BRIEF SUMMARY OF THE INVENTION

The Bravo Waste Bin has two compartments, one for waste storage, and one for the storage of tools and cleaning supplies. The second compartment provides several advantages, including a hanging hook for the flyswatter, a mesh pouch with an opening at the top to provide a holding place for the trash bags. In addition, there is room for storage of a mini-sweep and dustpan, as well as a broom with an adjustable handle inside the second compartment.

The Bravo Waste Bin provides a convenient location to store all necessary tools and cleaning supplies. The Bravo Waste Bin enables the user to quickly clean or pick up waste items, saving time and energy. These features provide the users and businesses the most convenient and sanitary way to clean, remove, and store waste, as well as the tools and supplies necessary for this task.

### BRIEF DESCRIPTION OF THE SEVERAL VIEWS OF THE DRAWING

FIG. 1 depicts the overview of the Bravo Waste Bin, including the two compartments.

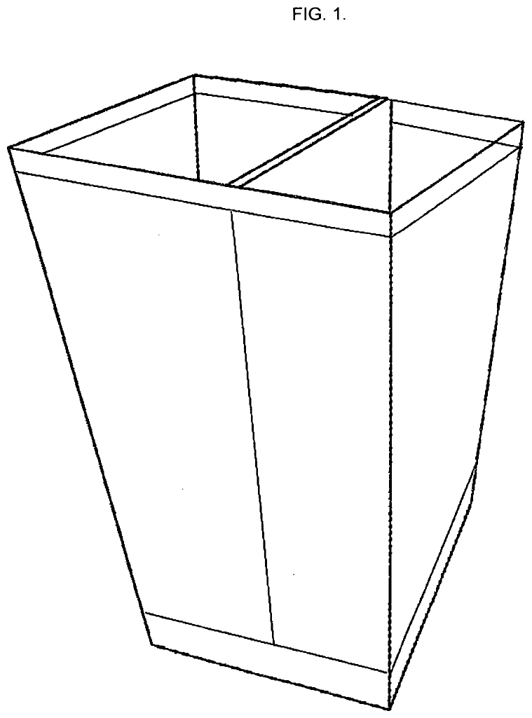

FIG. 2 depicts different components of the Bravo Waste Bin, including the top ring, bottom holder, hanging hooks for the flyswatter, mesh pouch for the storage of trash bags, room for storage of a broom with an adjustable handle, and a mini-sweep and dustpan. These items are for illustration purposes only, since different tools and cleaning supplies can be stored inside.

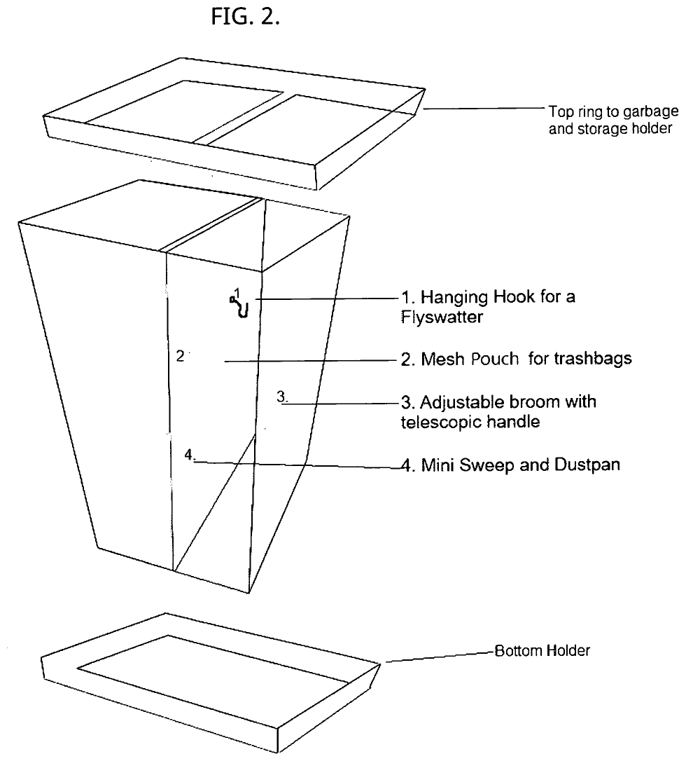

### DETAILED DESCRIPTION OF THE INVENTION

The Bravo Waste Bin includes an additional compartment to the traditional waste bin. This additional or second compartment is connected to the traditional waste bin. The Bravo Waste Bin, therefore, has two compartments, one for waste storage, and one for the storage of the tools and cleaning supplies. The Bravo Waste Bin can be made from any materials suitable for waste storage, such as plastic, stainless steel, or a combination.

The second compartment is connected to the traditional waste bin either by a permanent connection or as a separate attachment. For a permanent connection, two compartments are parts of a solid bin, with a divider in the middle. As a separate attachment, the second compartment is attached to the traditional waste bin by means of attaching the two compartments together.

The second compartment provides several advantages, including a hanging hook for the flyswatter, a mesh pouch with an opening at the top to provide a holding place for the trash bags. In addition, there is room for storage of a mini-sweep and dustpan at the bottom of the second compartment, as well as room for a broom with an adjustable handle.

The hanging hook is attached to the wall inside of second compartment. The hanging hook can be attached to any wall inside of the second compartment. The hanging hook can be made of any material that can provide support for different items, such as the flyswatter.

The mesh pouch with an opening at the top is used as the storage place for the trash bags, or other tools or cleaning supplies. The mesh pouch is attached to any wall inside of the second compartment. The mesh pouch can be made from any suitable flexible or inflexible material for the storage of the trash bags or tools or cleaning supplies.

A broom with an adjustable handle can be stored inside the second compartment.

A mini-sweep and dust pan can be stored inside the second compartment.

The top-ring holder is placed on top of the two compartments to secure the trash bag, as well as to provide a complete look to the Bravo Waste Bin. The top-ring holder can be made from any suitable flexible or inflexible material to function as a top-ring holder.

The bottom holder is at the bottom of the two compartments, to securely hold them in place, and provides a complete look to the Bravo Waste Bin. The bottom holder can be made from any suitable flexible or inflexible material to function as a bottom holder.

The accessories or tools described above are for illustration purposes only. The second compartment can be utilized to store different accessories, tools, or supplies needed for cleaning and waste removal.

I claim:

1. An apparatus comprising of:
the first compartment as a waste bin for waste storage;
the second compartment as a storage bin for the storage of the cleaning tools and supplies;
the first and second compartments are connected via a permanent connection or as a separate attachment; for a permanent connection, two compartments are parts of a solid bin, with a divider in the middle; for a separate attachment, the second compartment is attached to the traditional waste bin by means of attaching the two compartments together;
the top ring as a mean to hold the trash bag in place;
the bottom holder as a mean to protect the floor.

2. The apparatus in claim 1, further comprising:
a hanging hook, made of any material that can provide support for a cleaning tool or supply, is attached to any wall inside of second compartment;
a mesh pouch or any suitable flexible or inflexible material for the storage of the trash bags, with an opening at the top, is attached to any wall inside of the second compartment.
